(19) United States
(12) Patent Application Publication
(10) Pub. No.: US 2008/0101637 A1
(43) Pub. Date: May 1, 2008

(54) Sound conductor and hearing apparatus

(75) Inventors: Wai Kit David Ho, Singapore (SG); Wee Haw Koo, Singapore (SG); Beng Hai Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 11/906,494

(22) Filed: Oct. 2, 2007

(30) Foreign Application Priority Data
Oct. 2, 2006 (DE) 102006046698.5

(51) Int. Cl. H04R 25/00

(52) U.S. Cl. 381/328; 381/322

(57) ABSTRACT

A sound conductor for a hearing apparatus is provided. A first end is fastenable to an acoustic unit of the hearing apparatus and a second end of which is fastenable to a housing of the hearing apparatus, with a middle longitudinal curve being defined for the sound conductor, with the sound conductor comprising at least one flexible section, which can be deformed in a reversible fashion, and with a length of the middle longitudinal curve being changeable from one first value to a second value by deforming the flexible section of the sound conductor, and the middle longitudinal curve maintaining the second value for the length until a predetermined minimal force for deforming the flexible section is exerted onto the sound conductor. Furthermore, a corresponding hearing apparatus is described with a housing and an acoustic unit, which are connected to one another with the aid of a sound conductor.

### CROSS REFERENCE TO RELATED APPLICATIONS

This application claims priority of German application No. 102006046698.5 DE filed Oct. 2, 2006, which is incorporated by reference herein in its entirety.

### FIELD OF INVENTION

The invention relates to a sound conductor for a hearing apparatus, the first end of which can be fastened to an acoustic unit of the hearing apparatus and the second end of which can be fastened to a housing of the hearing apparatus, with a middle longitudinal curve being defined for the sound conductor and with the sound conductor having at least one flexible section, which can be deformed in a reversible fashion. A corresponding hearing apparatus is also described.

### BACKGROUND OF INVENTION

Hearing devices are portable hearing apparatuses which are used to supply the hard of hearing. To accommodate the numerous individual requirements, different configurations of hearing devices such as behind-the-ear hearing devices (BTE), in-the-ear hearing devices (ITE), concha hearing devices, are provided. The hearing devices described by way of example are worn on the outer ear or in the auditory canal. Furthermore, bone conduction hearing aids, implantable or vibrotactile hearing aids are also available on the market. The damaged ear is herewith either stimulated mechanically or electrically.

Essential components of the hearing devices include in principal an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This main configuration is shown in the example in FIG. 1 of a behind-the-ear hearing device. One or a number of microphones 2 for recording the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound conductor or sound tube (not shown), which is fixed with an otoplastic in the auditory canal. The power supply of the hearing device and in particular of the signal processing unit 3 is provided by a battery 5 which is likewise integrated into the hearing device housing 1.

### SUMMARY OF INVENTION

The publication US 2006/0115105 A1 shows a hearing aid with a sound conductor. Reference is made here to the fact that the frequency response of the hearing device is inter alia dependent on the length of the sound conductor. The length is adjusted by moving the sound conductor into a position and then gluing it thereto. Deformation does not take place.

The publication DE 31 41 921 A1 likewise also discloses a hearing device with a sound conductor. A free end of a sound collar rests on one end of the sound conductor. The sound conductor is also not deformed here.

EP 1 571 882 A2 relates to a device for fastening a wax protection system to a hearing device. This device, which is embodied in a gripper-like manner, enables a wax protection system to be fastened to a sound outlet opening of a hearing device and to be removed therefrom.

U.S. Pat. No. 6,493,453 B2 describes a hearing device with a subunit, which is attached inside a protective housing to be worn as an earring. A further subunit with a loudspeaker to be worn in an auditory canal is connected to the protective housing by way of a connecting cord. In this case, the connecting cord has a rigidity which is comparable to fishing line strength. In addition, US 2001/038703 A1 relates to a hearing device, the tone-processing components of which are arranged on an at least partially foldable support element. Folding the support element allows the hearing device to be molded into a shape which can be inserted into an auditory canal or fastened behind an ear.

Furthermore, US 2004/0264723 A1 describes a plastic part which is to be worn in an auditory canal, an ITE for instance, with a loudspeaker. In order to prevent noises being automatically generated by the loudspeaker when the plastic part is hit, the loudspeaker is fastened in a spacious cavity of the plastic part by way of a first and a second flexible connecting part. By fastening the loudspeaker with the aid of two flexible connecting parts, the loudspeaker is to be induced to vibrate when the plastic part is hit, without the loudspeaker herewith hitting against the plastic part.

Manufacturing an ITE with a loudspeaker according to US 2004/0264723 A1 is however very expensive. As an outer form of the plastic part has to be individually adjusted to the auditory canal of a future user, the two connecting parts must also be frequently deformed such that they correspond to the special form of the plastic part. This renders the manufacture of flexible connecting parts very time-consuming and labor-intensive. Furthermore, the insertion of the two flexible connecting parts with the loudspeaker into the plastic part is associated with additional work steps. This disadvantage also applies to a BTE with a loudspeaker according to US 2004/0264723 A1, since the users, who decide on this type of hearing device, prefer different models with different dimensions for a BTE. A manufacturer must thus adjust the individual parts of a BTE to the dimensions of the respective model. By way of example, the sound tubes or sound conductors, which are used to forward a tone signal generated by the loudspeaker via the holding hooks of the BTE (earhook) into the inner of the auditory canal, comprise different lengths and different bending angles.

The object of the present invention consists in providing a possibility, by way of which a hearing device can be equipped with a hearing device component in a more cost-effective fashion.

The object is achieved by a sound conductor for a hearing apparatus, the first end of which can be fastened to an acoustic unit and the second end of which can be fastened to a housing of the hearing apparatus, with a middle longitudinal curve being defined for the sound conductor, with the sound conductor comprising at least one flexible section, which can be deformed in a reversible fashion, and with a length of the middle longitudinal curve being changeable from a first value to a second value by deforming the flexible section of the sound conductor, and the middle longitudinal curve, after deformation, maintaining the second value for the length until a predetermined minimal force is exerted on the sound conductor in order to deform the flexible section. The term sound conductor also includes a sound tube, the second end of which is connected to an otoplastic as part of a housing.

The object is likewise achieved by a hearing apparatus with a housing and an acoustic unit, which are connected to one another with the aid of a sound conductor according to the invention.

A possibility thus exists of reforming a sound conductor according to the invention in a simple manner, such that its form is adjusted to the respective model of a hearing apparatus, into which it is to be inserted. With the aid of the present invention, it is thus no longer necessary to manufacture sound conductors with different lengths and different bending forms, or to deform a sound conductor in a complicated method into a desired end form. This reduces both the amount of work required and manufacturing costs for the respective hearing apparatus. The fastening of both ends of the sound conductor to a housing or to the loudspeaker can occur with the aid of connecting parts specially designed for that purpose. The flexible subunit of the sound conductor can preferably be deformed by a force which can be applied manually and/or at room temperature.

In particular, a deformation of the flexible section of the sound conductor enables a curvature of the middle longitudinal curve of the sound conductor to be changed in a reversible manner. A sound conductor, starting from a basic form, can also be adjusted to different models of a hearing apparatus in a simple manner by way of bending the flexible subunit.

The sound conductor can be embodied here in one piece and/or made out of metal. A corresponding sound conductor can be manufactured easily and can be inserted into a hearing apparatus in a simple fashion.

The flexible section of the sound conductor is a goose neck for instance, which is either embodied in the manner of an accordion or is formed from rings with cuffs which can be displaced relative to one another. A goose neck ensures a simple deformation of the flexible subunit starting from a basic form into many different end forms with the aid of a force which can be easily applied by a person at room temperature.

The acoustic unit can be a loudspeaker so that a sound signal generated by the loudspeaker is forwarded to a tone outlet opening of the housing by means of the sound conductor. The tone outlet opening can be arranged here on an otoplastic as part of the housing.

The housing can likewise be a housing of an in-the-ear hearing device (ITE). A corresponding ITE is also advantageous compared with the prior art with two flexible connecting parts in that only one connecting part for fastening the loudspeaker in a cavity of the ITE is required with the sound conductor. This saves on the amount of work required to manufacture a second connecting part and to fasten the second connecting part in an ITE. A hearing apparatus according to the invention can however also be embodied as a behind-the-ear hearing device (BTE) or as a concha hearing device.

### BRIEF DESCRIPTION OF THE DRAWINGS

The present invention is now described with reference to the appended drawings, in which

FIG. 1 shows a conventional behind-the-ear hearing device (BTE),

FIG. 2 shows a sound conductor according to the invention with a flexible subunit in a basic form, and

FIGS. 3 to 5 show the sound conductor according to the invention with the flexible subunit in the different end forms.

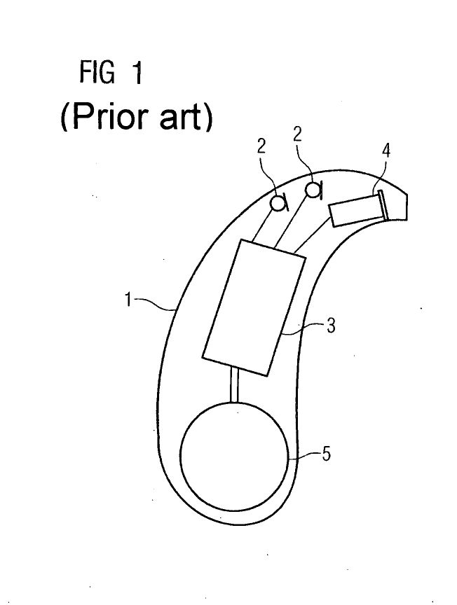

### DETAILED DESCRIPTION OF INVENTION

The exemplary embodiment illustrated in more detail below represents a preferred embodiment of the present invention.

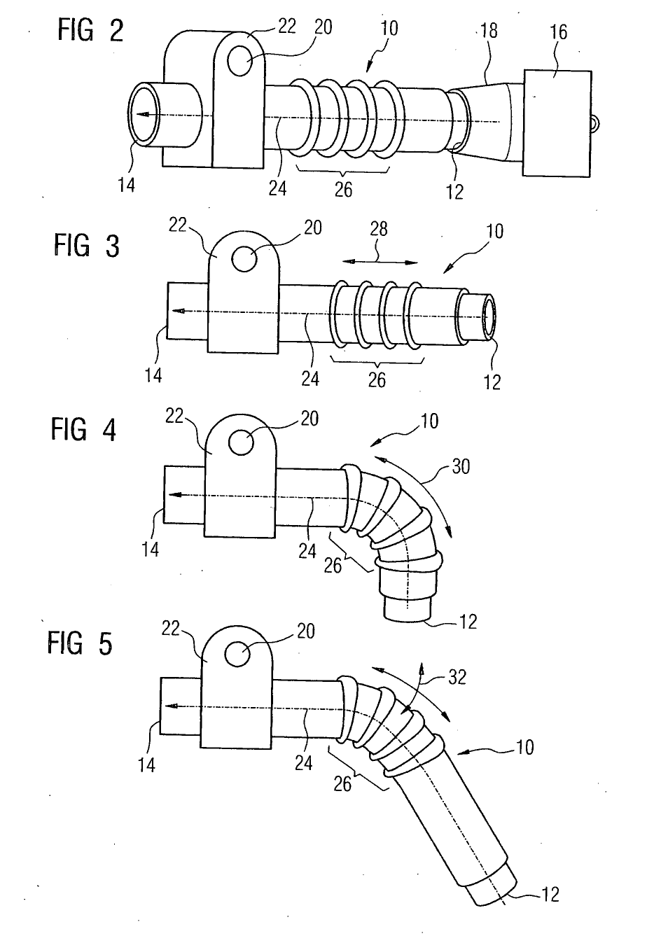

FIG. 2 shows a basic form of a sound conductor 10 according to the invention. The sound conductor 10 is formed in one piece from metal and comprises an approximately tubular cavity, which runs from a first end 12 to a second end 14 of the sound conductor 10. The first end 12 of the sound conductor 10 is used to fasten the sound conductor 10 to a loudspeaker 16. It is formed such that an opening of a plastic cylindrical fastening part 18, the other opening of which is fastened to the loudspeaker 16, can be applied thereto with minimal force.

The second end 14 of the sound conductor 10 can be fastened to a housing of a behind-the-ear hearing device (BTE) (not shown) with the aid of a screw (also not shown). The screw is guided here through a recess 20 of a fastening component 22 in the vicinity of the second end 14 of the sound conductor 10. As an alternative hereto, the second end 14 of the sound conductor 10 is also embodied as a thread. In order to fasten a second end 14 of a sound conductor 10 equipped with a thread, said sound conductor 10 is rotated into a corresponding opening of the housing.

The sound conductor 10 is used to forward a sound signal emitted by the loudspeaker 16 along a middle longitudinal curve 24 of the sound conductor 10 to a sound outlet opening of a housing of a BTE which is located in the vicinity of the second end 14. A fastening hook (earhook) of the BTE can be attached to the sound outlet opening with a sound tube for instance. The sound signal is able to reach a unit of the hearing device which is fastened in an auditory canal of a user by way of the sound tube. As the fastening of a BTE to an ear of a user and the forwarding of sound signals from the fastened BTE into the auditory canal are not the subject matter of the present invention, no further mention is made thereto. A sound conductor 10 according to the invention can naturally also be embodied in one piece with a sound tube and/or a fastening hook when a suitable material is selected.

A sound conductor 10 according to the invention is suited to use in different models of a BTE. The different dimensions of different models of a BTE herewith are largely irrelevant, since the sound conductor 10 according to the invention has a goose neck 26, with the aid of which the shape of the sound conductor 10 can be adjusted to the respective model of a BTE. The goose neck 26 can be embodied here in the form of an accordion, as shown in FIG. 2. The goose neck 26 can likewise also be formed from a number of rings with cuffs which can be displaced in respect of one another.

FIGS. 3 to 5 reproduce different end forms of the sound conductor 10, into which the sound conductor 10 can be deformed by exerting a manual force at room temperature from the basic form shown in FIG. 2.

FIG. 3 shows the sound conductor 10 with an extended goose neck 26. The middle longitudinal curve 24 of the sound conductor 10 thus has a greater length in the end form in FIG. 3 than in the basic form in FIG. 2. As in FIG. 2, the middle longitudinal curve 24 also runs straight in FIG. 3.

The deformation of the sound conductor 10 from the basic form into the end form illustrated in FIG. 3 can be undone again by means of a force which can be applied manually. Arrow 28 illustrates this. The goose neck 26 can also be pressed together such that the middle longitudinal curve 24 comprises a shorter length compared with the basic form. This is also illustrated by way of arrow 28.

FIG. 4 shows the sound conductor 10 with an arched goose neck 26. The middle longitudinal curve 24 of the sound conductor 10 herewith comprises a length which remains unchanged compared with the basic form. A distance between the first end 12 and the second end 14 of the sound conductor 10 is certainly reduced compared with the basic form. As illustrated clearly by arrow 30, this bending of the goose neck 26 can likewise be undone.

The end form in FIG. 5 is a combination of the two end forms of FIG. 3 and FIG. 4. The goose neck 26 of the sound conductor 10 according to the invention can also be stretched and bent starting from the basic form. It is similarly possible to press and bend the goose neck 26 together. The arrow 32 shows that both processes are reversible. The possibility thus exists of adjusting a sound conductor 10 individually to the housing, into which the sound conductor 10 is to be inserted.

A sound conductor 10 according to the invention can also be used in an in-the-ear hearing device (ITE). To enable a user of an ITE to wear the ITE in his/her auditory canal in a comfortable fashion, the outer form of the plastic housing of the ITE must be individually adjusted to the auditory canal. This requires some components of the ITE, above all the connecting parts, to be adjusted to the respective form of the plastic housing. The present invention makes this possible in a very simple and cost-effective manner.

In addition to the goose neck 26, a sound conductor 10 can still comprise at least one further flexible subunit. The rigidity of the at least one flexible subunit can vary here compared with the rigidity of the gooseneck 26. The at least one flexible subunit can be used to induce the sound conductor 10 to oscillate when hitting against a hearing apparatus and thus to prevent the formation of noise.

1.-7. (canceled)

8. A sound conductor for a hearing apparatus, comprising
a first end constructed be fastened to an acoustic unit of the hearing apparatus;
a second end constructed to be fastened to a housing of the hearing apparatus;
a middle longitudinal curve between the first and second ends; and
at least one flexible section of the middle longitudinal curve, the flexible section deformable in a reversible manner,
wherein a length of the middle longitudinal curve is changable from a first value to a second value by way of deforming the flexible section, and
wherein after deformation, the middle longitudinal curve maintains the second value for the length until a predetermined minimal force is exerted onto the sound conductor.

9. The sound conductor as claimed in claim 8, wherein a curvature of the middle longitudinal curve of the sound conductor being changeable in a reversible fashion by deforming the flexible section of the sound conductor.

10. The sound conductor as claimed in claim 8, wherein the sound conductor is embodied in one piece and formed from metal.

11. The sound conductor as claimed in claim 8, wherein the sound conductor is embodied in one piece or formed from metal.

12. The sound conductor as claimed in claim 8, wherein the flexible section of the sound conductor is a goose neck, which is embodied in the form of an accordion or is formed from rings with cuffs which can be displaced relative to one another.

13. A hearing apparatus, comprising:
a housing;
an acoustic unit, and
a sound conductor having for connecting the housing to the acoustic unit, the sound conductor comprising a flexible section the flexible section deformable in a reversible manner,
wherein in order to connect the housing to the acoustic unit, a length of the sound conductor is changable from a first value to a second value by way of deforming the flexible section, and
wherein after deformation, the second value for the length is maintained until a predetermined minimal force is exerted onto the sound conductor.

14. The hearing apparatus as claimed in claim 13, wherein the sound conductor is embodied in one piece.

15. The hearing apparatus as claimed in claim 14, wherein the flexible section of the sound conductor is a goose neck, which is embodied in the form of an accordion or is formed from rings with cuffs which can be displaced relative to one another.

16. The hearing apparatus as claimed in claim 13, wherein the flexible section of the sound conductor is a goose neck, which is embodied in the form of an accordion or is formed from rings with cuffs which can be displaced relative to one another.

17. The hearing apparatus as claimed in claim 13, wherein the acoustic unit is a loudspeaker and that a sound signal generated by the loudspeaker is forwarded to a tone outlet opening of the housing by way of the sound conductor.

18. The hearing apparatus as claimed in claim 13, wherein the housing is an in-the-ear hearing device.
